(19) United States
(12) Patent Application Publication
(10) Pub. No.: US 2017/0063813 A1
(43) Pub. Date: Mar. 2, 2017

(54) Secure Packet Communication with Common Protocol

(71) Applicant: The Government of the United States, as represented by the Secretary of the Army, Washington, DC (US)

(72) Inventors: Robert Cole, Churchville, MD (US); Derya Cansever, Havre de Grace, MD (US)

(21) Appl. No.: 14/729,636

(22) Filed: Jun. 3, 2015

(51) Int. Cl. H04L 29/06; H04L 12/24

(52) U.S. Cl. CPC H04L 63/0471; H04L 41/12; H04L 63/0281

(57) ABSTRACT

Various embodiments are described that relate to secure packet communication with common protocol. Enclaves of a higher security level can employ a network architecture of a lower security level to transmit higher level packets securely. Devices can be employed that encrypt final address information to the network architecture, but add address information for a network architecture location that interfaces with a final destination associated with the final address information. Once the packet travels to the interface location, the encrypted portion can be decrypted and transferred to the final destination.

### GOVERNMENT INTEREST

The innovation described herein may be manufactured, used, imported, sold, and licensed by or for the Government of the United States of America without the payment of any royalty thereon or therefor.

### BACKGROUND

Digital information can be transmitted across a network. In one example, different portions of the network can have a common security level. With this, a single packet with access privileges set to that security level can be transmitted across different portions of the network without concern of a lower level network portion accessing the packet. However, if the different network portions do not share the same security level, specifically if a network portion is of a lower security level, then a concern can arise.

### SUMMARY

In one embodiment, a method can be performed, at least in part, by a network device. The method can comprise identifying a destination enclave for a packet and causing a transmission of the packet to the destination enclave. The transmission of the packet to the destination enclave can include travel across an intermediary network. The destination enclave and a transmission enclave that supplies the packet can share a security level that is of a higher level than a security level of the intermediary network. In addition, the transmission enclave, the destination enclave, and the intermediary network share a common protocol.

In one embodiment, a method is performed, at least in part, by a first router that interfaces a destination enclave with an intermediary network. The method can comprise receiving a packet, that is partially encrypted, from a second router that encrypted the packet that travels by way of the intermediary network and decrypting the packet. The second router interfaces with a submission enclave while the intermediary network can be incapable of decrypting the packet. The destination enclave and the submission enclave can share a security level that is of a higher level than a security level of the intermediary network. The submission enclave, the destination enclave, and the intermediary network can share a common protocol.

In one embodiment, a system comprises an assignment component and a transfer component, where the assignment component, the transfer component, or a combination therefore are implemented, at least in part, by way of non-software. The assignment component can configured to assign an intermediary network destination information set to a packet with a final destination information set. The transfer component can be configured to cause transmission of the packet with the intermediary network destination information set from a multi-color router, along an intermediary network, toward a destination enclave. The final destination information set can correspond to the destination enclave, can be intelligible to a transmission enclave operatively coupled to the multi-color router, can be intelligible to the destination enclave, and can be not intelligible to the intermediary network. The intermediary network destination information set can be a final destination of the intermediary network and the final destination of the intermediary network can be accessible by the destination enclave, where the transmission enclave, the destination enclave, and the intermediary network can share a common protocol.

### BRIEF DESCRIPTION OF THE DRAWINGS

Incorporated herein are drawings that constitute a part of the specification and illustrate embodiments of the detailed description. The detailed description will now be described further with reference to the accompanying drawings as follows:

FIG. 1 illustrates one embodiment of a network;

FIG. 2 illustrates one embodiment of a system comprising an assignment component and a transfer component;

FIG. 3 illustrates one embodiment of a system comprising the assignment component, the transfer component, an identification component and an addition component;

FIG. 4 illustrates one embodiment of a system comprising the assignment component, the transfer component, an encryption component, and a decryption component;

FIG. 5 illustrates one embodiment of a system comprising the assignment component, the transfer component, an analysis component, and a path component;

FIG. 6 illustrates one embodiment of a system comprising a processor and a computer-readable medium;

FIG. 7 illustrates one embodiment of a method comprising two actions;

FIG. 8 illustrates one embodiment of a method comprising four actions;

FIG. 9 illustrates one embodiment of a method comprising four actions;

FIG. 10 illustrates one embodiment of a method comprising two actions; and

FIG. 11 illustrates one embodiment of a method comprising three actions.

### DETAILED DESCRIPTION

A network can comprise a series of red enclaves with a higher security level and a black core portion of a lower security level. Transitioning between the red enclaves and the black core portion can be individual bi-color routers. When a packet is to be sent from a transmission red enclave, along the black core portion, ultimately to a reception red enclave, the bi-color router can process and modify the packet for this transmission. The bi-color router can encrypt an address of the reception red enclave such that the address cannot be read by the black core portion but can be decrypted by another bi-color router of the same classification level. In addition, the bi-color router can add an address of a bi-color router associated with the reception red enclave as the destination address to the modified packet. This address of the bi-color router associated with the reception red enclave is not encrypted such that the black core portion can read the address. In this, the black core portion can transfer the packed to the bi-color router associated with the reception red enclave. The bi-color router associated with the reception red enclave can decrypt the address of the reception red enclave and cause the packet to travel to the reception red enclave.

The following includes definitions of selected terms employed herein. The definitions include various examples. The examples are not intended to be limiting.

“One embodiment”, “an embodiment”, “one example”, “an example”, and so on, indicate that the embodiment(s) or example(s) can include a particular feature, structure, characteristic, property, or element, but that not every embodiment or example necessarily includes that particular feature, structure, characteristic, property or element. Furthermore, repeated use of the phrase “in one embodiment” may or may not refer to the same embodiment.

“Computer-readable medium”, as used herein, refers to a medium that stores signals, instructions and/or data. Examples of a computer-readable medium include, but are not limited to, non-volatile media and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, other optical medium, a Random Access Memory (RAM), a Read-Only Memory (ROM), a memory chip or card, a memory stick, and other media from which a computer, a processor or other electronic device can read. In one embodiment, the computer-readable medium is a non-transitory computer-readable medium.

“Component”, as used herein, includes but is not limited to hardware, firmware, software stored on a computer-readable medium or in execution on a machine, and/or combinations of each to perform a function(s) or an action(s), and/or to cause a function or action from another component, method, and/or system. Component may include a software controlled microprocessor, a discrete component, an analog circuit, a digital circuit, a programmed logic device, a memory device containing instructions, and so on. Where multiple components are described, it may be possible to incorporate the multiple components into one physical component or conversely, where a single component is described, it may be possible to distribute that single component between multiple components.

“Software”, as used herein, includes but is not limited to, one or more executable instructions stored on a computer-readable medium that cause a computer, processor, or other electronic device to perform functions, actions and/or behave in a desired manner. The instructions may be embodied in various forms including routines, algorithms, modules, methods, threads, and/or programs including separate applications or code from dynamically linked libraries.

“Black core portion”, as used herein, can refer to a set of backbone nodes used in transporting encrypted packets. The black core portion can be designed to carry packets of differing authorized classification levels, without indicating the classification levels of individual packets. The black core portion can be used to interconnect red enclaves.

“Red enclave”, as used herein, can refer to a set of network elements (e.g., hosts, routers, etc.). The network elements can be of the same classification level (e.g., unclassified, controlled unclassified information, or classified). Network elements within a red enclave may use encryption and/or physical security to protect the classified data within the red enclave.

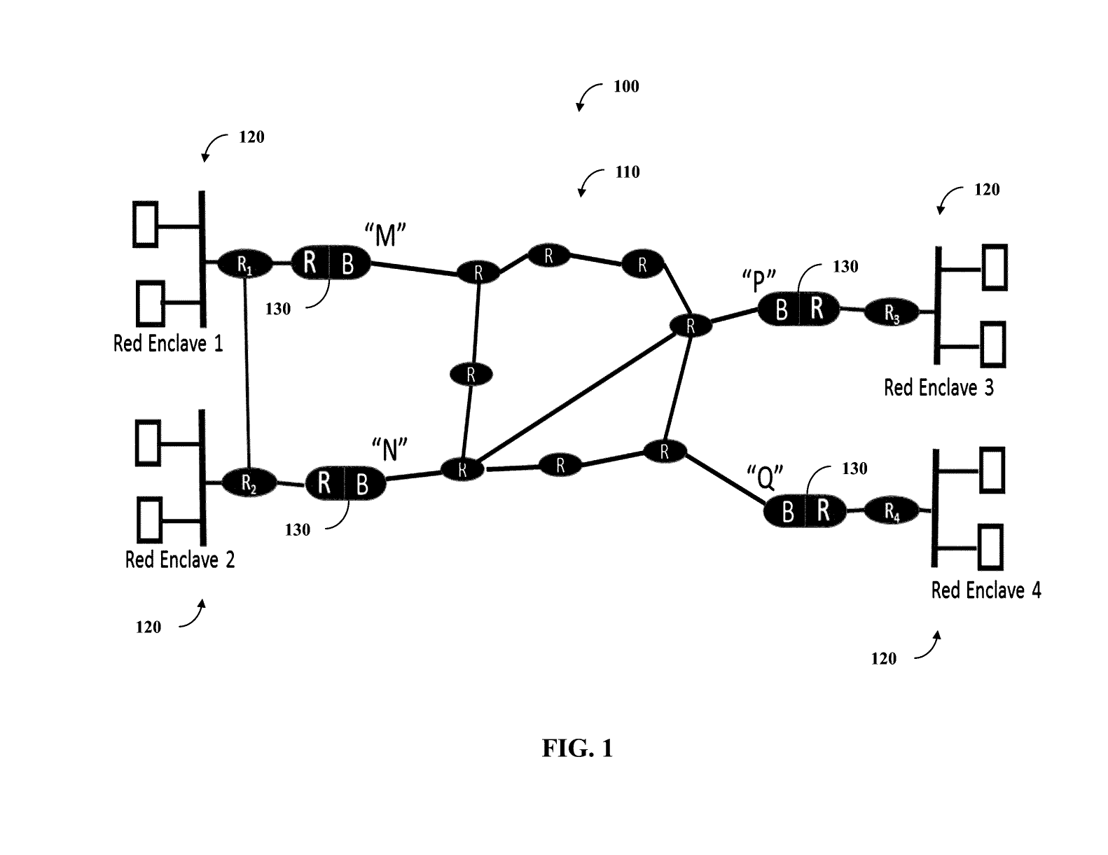

FIG. 1 illustrates one embodiment of a network 100. The network 100 can comprise a black core portion 110 and four red enclaves 120 (individually designated as red enclaves 1-4), but other configurations can be used (e.g., two black core portions and three red enclaves). The black core portion 110 can be of a lower security level while the red enclaves 120 can be of a higher security level. In one example, the network 100 can be a network for a law firm. The red enclaves 120 can process confidential information while the black core portion 110 can process non-confidential information.

A situation can arise where confidential information is to be transmitted from red enclave 1 to red enclave 4. In this situation, a desire can be to use the black core portion 110 as a pathway between these two red enclaves. Since the black core portion 110 is not of a high enough security level to process the confidential information in of itself, the black core portion 110 cannot be used without further actions.

In one embodiment, the network 100 can employ High Assurance Internet Protocol Encryptor (HAIPE) devices that function as demarcation points between the red enclaves 120 and the black core portion 110. The HAIPE devices can employ look-up tables to associate black core addresses with red enclave addresses. However, use of these HAIPE devices can have several drawbacks. First, the network 100 with the HAIPE devices may have multiple protocols (e.g., individual red enclave protocols and black core protocol) that lead to stale information through routing overlay. Further, a red enclave 120 may be unable to appreciate a topology of the network 100 when HAIPE devices are employed. In addition, problems could arise if a red enclave 120 changes its attachment point to the black core portion 110.

Therefore, instead of using HAIPE devices the network 100 can employ multi-color routers that are shown in FIG. 1 as bi-color routers 130. The term ‘bi-color’ is to indicate that the routers 130 work with a red enclave 120 as well as the black portion 110 and thus two colors are used—red and black. The multi-color routers can be for other numbers, such as tri-color routers if a third color is used. In one example, green and red enclaves can exist with different security levels than the black core portion 110 and different security levels from one another. Therefore, as opposed to using the bi-color routers 130, tri-color routers can be used.

The bi-color routers 130 can include designators M, N, P and Q that represent black Internet Protocol (IP) addresses of bi-color routers 130 that are hereafter referred to as the names of the bi-color routers 130. A difference between a bi-color router 130 and a HAIPE Device is that the bi-color router 130 can be configured to run absent a HAIPE Address Resolution Protocol. The bi-color router 130 can function as two virtual routers, one interfacing a red enclave 120 the other interfacing the black core portion 110. The bi-color routers 130, function as virtual routers, can, in one embodiment, reside in the same hardware with an encryptor/decryptor residing between them and this hardware can be part of the network 100.

The network 100 can function with an Integrated Routing method. With this method, the red portion of the bi-color router 130 can produce a Link State Advertisement (LSA) message describing a topology of the red enclave 120 to which the bi-color router interfaces. The bi-color router 130 can encrypt the LSA message at its red portion and pass the LSA message to the black portion of the bi-color router 130. The red portion of the bi-color router 130 can store this information in a route information database to compute optimal routes across the black core portion 110. The bi-color router 130 can also encrypt the LSA message, to produce a red LSA message, in such a way that only a bi-color router 130 with the same classification level (or higher) can decrypt the red LSA message. In one example, the bi-color router 130 named “P” can encrypt the LSA message such that it can be decrypted by the bi-color routers 130 named “M”, “N”, or “Q”, but not the black core portion 110. The red LSA message can be appended to a black core LSA message and the combination can be forwarded to the black core portion 110, as specified by an underlying routing protocol. To this end, the sender bi-color router 130 can use an Opaque LSA Option as defined in a protocol specification (e.g., RFC 5250), so that routers other than the appropriate ones (e.g., a bi-color routers 130 with the same classification level as the originating red enclave that is associated with a destination enclave) can ignore the encrypted part. The properly encrypted LSA message can be received and decrypted by a bi-color router 130 of the same classification level as a producer of the encrypted LSA message. The exchange of properly encrypted LSA messages allows the bi-color routers 130 to have a global view of the network 100 and thus to identify the optimal egress bi-color routers 130. Passing these LSAs into the red enclaves 120 allows red-side routers to have complete topology information for improved routing decisions. Since this decision is based on the latest routing update, the likelihood of stale information corrupting routing decisions is minimized. Then, the ingress bi-color router 130 can encrypt the red packet and encapsulate it with a new IP Header that describes a Destination Address that is the Black IP address of the egress bi-color router 130. The receiving bi-color router 130 can peel the header off, decrypt the content and forward the remaining packet to its destination in the red enclave 120. In one example, when a packet is headed from red enclave 3 to red enclave 1, the bi-color router 130 in front of red enclave 3, after encrypting it, can encapsulate the packet with an IP Header with the Destination Address “N” and Source Address “P”.

The proposed integrated routing method obviates usefulness of the HAIPE Discovery Protocol and thus minimizes the likelihood of using stale information. Further, this routing method avoids selection of non-optimal egress routers. Use of this routing method can also improve convergence times for routing in dynamic networks by eliminating multiple routing layers. There can be a trade-off between the query-response traffic of HAIPE Discovery Protocol and the idea that the encrypted LSA messages of the red enclaves 120 are to be distributed in the black core portion 110, even to black routers that are part of the black core portion 110, who do not need them. Indiscriminate forwarding of encrypted red enclave LSA messages has the advantage that multiple routers can receive them, so traffic analysis attacks become more difficult.

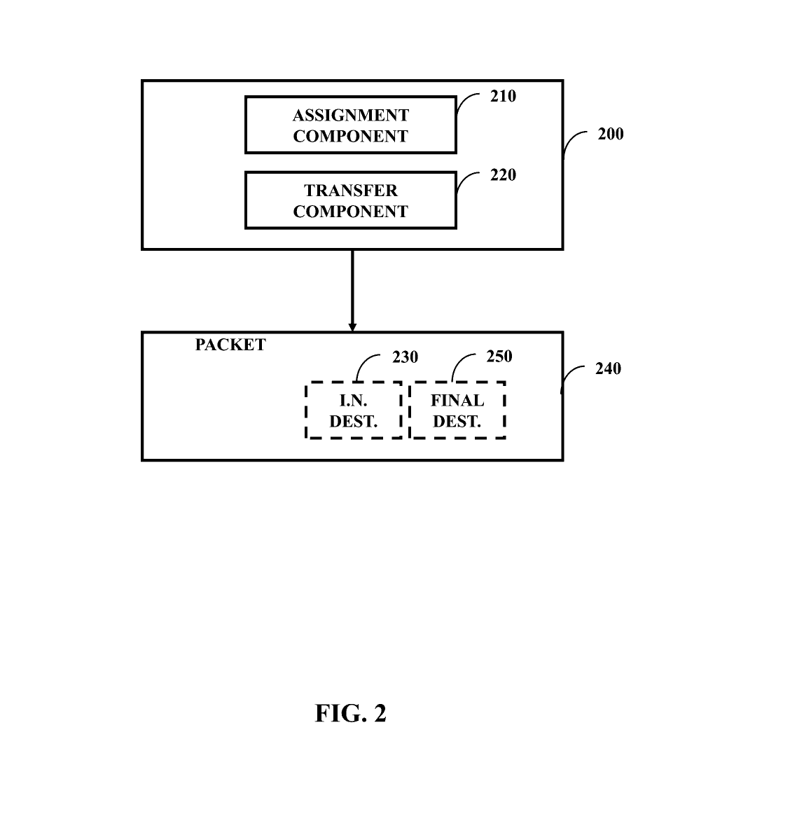

FIG. 2 illustrates one embodiment of a system 200 comprising an assignment component 210 and a transfer component 220. The assignment component 210 can be configured to assign an intermediary network destination information set (e.g., i.n. dest. 230—short for intermediary network destination 230—that can be the IP Header) to a packet 240 with a final information data set (e.g., the final dest. 250—short for final destination 250—that can function as the red LSA message). The transfer component 220 can be configured to cause transmission of the packet 240 with the intermediary network destination information set from a multi-color router, along an intermediary network, towards a destination enclave. In one embodiment, transmission from the multi-color router can be considered transmission from a transmission enclave since the multi-color router can be considered part of both the transmission enclave and the intermediary network since it has aspects of both. The final destination information set can be intelligible to the transmission enclave and the destination enclave (able to be understood by the transmission enclave and the destination enclave such as being encrypted and decryptable by the enclaves), yet not intelligible to the intermediary network (not able to be understood by the intermediary network, such as being encrypted and not decryptable by the intermediary network). The intermediary network destination information set can indicate a final destination of the intermediary network accessible by the destination enclave. The transmission enclave, the destination enclave, and the intermediary network can share a common protocol.

In one example, the system 200 can function with the network 100 of FIG. 1 with the intermediary network being the black core portion 110 of FIG. 1, the transmission enclave can be red enclave 2, the multi-color router being the bi-color router 130 named “N”, and the destination enclave can be red enclave 3. The system 200 can reside, at least in part, on the bi-color router 130 named “N” that is associated with red enclave 2. The system 200 can determine that the packet 240 is to ultimately arrive at red enclave 3 and the packet 240 can include the final destination information set that indicates red enclave 3. The system 200 can determine that red enclave 3 is associated with the bi-color router 130 of FIG. 1 named “P” and the assignment component 210 can assign the address of “P” to the packet 240 as the intermediary network destination information set. The transmission component 220 can cause the packet 240 to travel from the bi-color router 130 of FIG. 1 named “N”, along the black core portion 110 of FIG. 1, and to the bi-color router 130 of FIG. 1 named “P.” The packet 240 can include red enclave 3 destination information, but this information is not knowable to the black core portion 110 while being knowable to the routers 130 of FIG. 1.

The final destination of the intermediary network can interface with a transitional enclave and the packet 240 travels from the transitional enclave to the destination enclave without return to the intermediary network. Returning to FIG. 1, red enclave 1 and red enclave 2 directly connect with one another so that the packet 240 can travel between them without travelling along the black core portion 110 of FIG. 1. Red enclave 3 can be the transmission enclave and red enclave 2 can be the destination enclave. System 200 can determine an optimal path of travel for the packet 240 and this determination can result in a path that comprises travel from the bi-color router 130 of FIG. 1 named “P” to the bi-color router 130 of FIG. 1 named “M” along the black core portion 110 of FIG. 1 and then from red enclave 1 to red enclave 2 along a direct path between the enclaves. Therefore, even though the final destination—red enclave 2—is associated with the bi-color router 130 of FIG. 1 named “N”, the transmission component 220 can cause transmission of the packet to a different bi-color router 130 of FIG. 1.

In one embodiment, red enclave 1 can have a packet for transmission to red enclave 4. The red router of FIG. 1 labeled as R1 can analyze the packet and determine that the final destination is red enclave 4. The red router of FIG. 1 labeled as R1 can select to have the packet sent to the bi-color router 130 named “N” instead of “M” if that would result in a better path.

The intermediary network destination information set can correspond to the destination enclave. Example of this can be the bi-color router 130 of FIG. 1 named “M” corresponding the red enclave 1, the bi-color router 130 of FIG. 1 named “N” corresponding the red enclave 2, the bi-color router 130 of FIG. 1 named “P” corresponding the red enclave 3, and the bi-color router 130 of FIG. 1 named “Q” corresponding the red enclave 4. The packet, absent the intermediary network final destination information set, can be not intelligible to the intermediary network (e.g., encrypted) or can be intelligible.

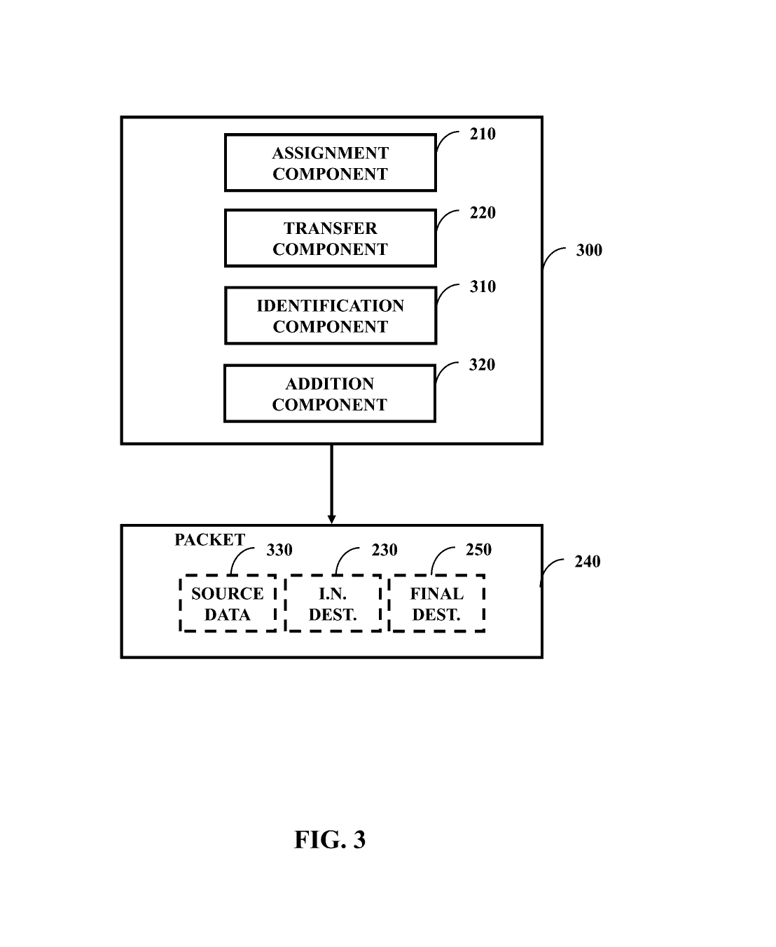

FIG. 3 illustrates one embodiment of a system 300 comprising the assignment component 210, the transfer component 220, an identification component 310 and an addition component 320. A destination may want to know a source of a packet and therefore the system 300 can augment the packet with source information. The identification component 310 can be configured to identify a source of the packet 240. The source can be the bi-color router 130 of FIG. 1 that functions as a gateway to the black core portion 110 of FIG. 1 or the source can be the red enclave 120 of FIG. 1 that provides the packet 240. The addition component 320 can be configured to add a source information set (e.g., the source data 330) to the packet 240 that indicates the source. The source information set can be intelligible or not intelligible (e.g., incomprehensible, unreadable, or undetectable) to the intermediary network.

In an example highlighted through discussion of FIG. 1, the red enclave 4 could produce a packet for transmission to red enclave 3. The source data 330 can include text of “red enclave 4” and “router Q” that indicates the actual source and black core source, respectively. The text “red enclave 4” can be encrypted and this encryption can be non-decipherable by the black core portion 110 of FIG. 1 and decryptable by the bi-color router 130 of FIG. 1 named “P.” The text “router Q” can be non-encrypted and thus readable by the black core portion 110 of FIG. 1 as well as a red enclave 120 of FIG. 1. In functioning, the black core portion 110 of FIG. 1 can send the packet to the bi-color router 130 of FIG. 1 named “P” since that is what the black core portion 110 of FIG. 1 can understand. Once at the bi-color router 130 of FIG. 1 named “P”, the bi-color router 130 of FIG. 1 named “P” can decrypt the final dest. To determine that the final destination is red enclave 4 of FIG. 1. The bi-color router 130 of FIG. 1 named “P” can remove the i.n. dest. 230 and the final dest. 250 before transmission to red enclave 4 of FIG. 1.

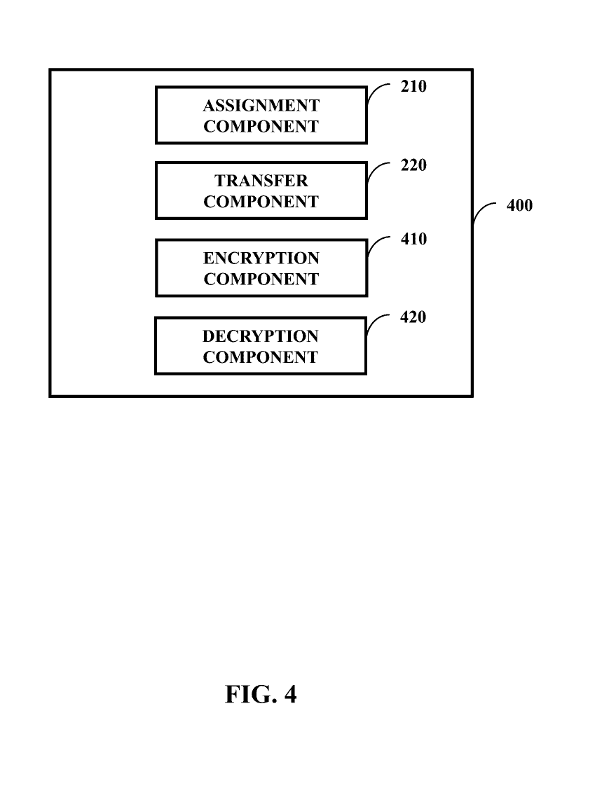

FIG. 4 illustrates one embodiment of a system 400 comprising the assignment component 210, the transfer component 220, an encryption component 410, and a decryption component 420. The encryption component 410 can be configured to encrypt the final destination information set such that the final destination information set is intelligible to the transmission enclave. The encryption can also be such that the final destination information set is intelligible to the destination enclave. Further the encryption can be such that the final destination information set is not intelligible to the intermediary network. The decryption component 420 can be configured to decrypt a second final destination information set of a second packet that is different from the packet 240 of FIG. 1 (e.g., the decryption component 420 can decrypt multiple packets simultaneously).

The system 400, along with other components disclosed herein, can be resident upon a bi-color router 130 of FIG. 1. The encryption component 410 can encrypt information while the decryption component 420 can decrypt information. However, since the network 100 of FIG. 1 can function to transmit information from one red enclave 120 to another and in turn one bi-color router 130 to another, the encryption component 410 and decryption component 420 can be configured to process different information. In one example, the system 400 can encrypt one packet while decrypting a difference packet. Packet decryption can include decryption of address information and/or decryption of substantive content of the packet. The same key can be used in this encryption/decryption or different keys can be used.

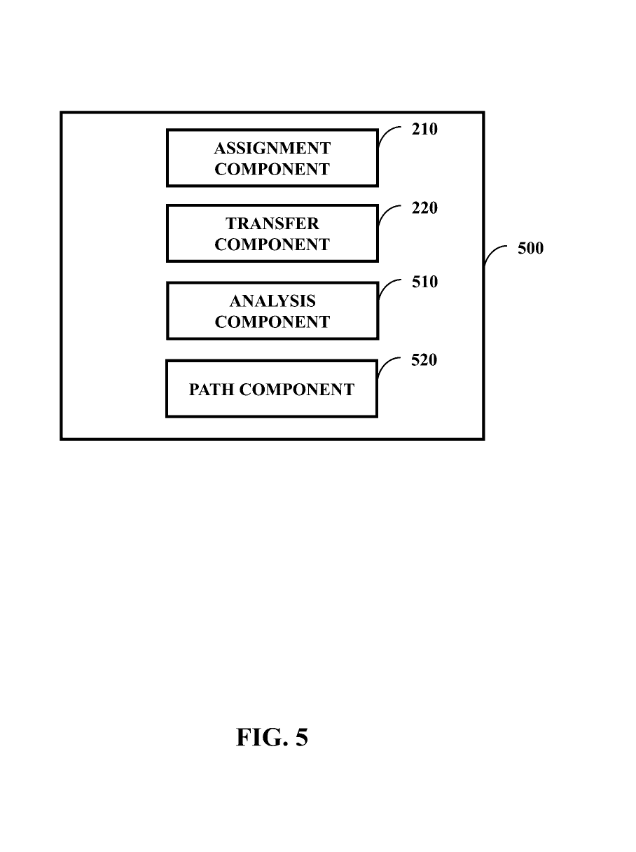

FIG. 5 illustrates one embodiment of a system 500 comprising the assignment component 210, the transfer component 220, an analysis component 510, and a path component 520. The analysis component 510 can be configured to analyze a topology of the intermediary network and at least one enclave that interfaces the intermediary network to produce an analysis result. The path component 520 can be configured to calculate a preferred path for the packet from the transmission enclave and/or associated bi-color router 130 of FIG. 1 and to the destination enclave and/or associated bi-color router 130 of FIG. 1 based, at least in part, on the analysis result. The transfer component 220 can be configured to cause transmission of the packet along the preferred path.

Returning to FIG. 1, the analysis component 520 can analyze the network 100. This analysis can include analysis of router processing times for individual routers of the black core portion 110, analysis of available direct pathways between red enclaves 120, and other analysis. Based on this analysis, the path component 520 can determine a preferred path (e.g., optimal path). This preferred path can be based on various factors such as speed and/or security (e.g., a fastest path, a most secure path, a path that meets a speed of x and a security threshold of y with x and y being real numbers).

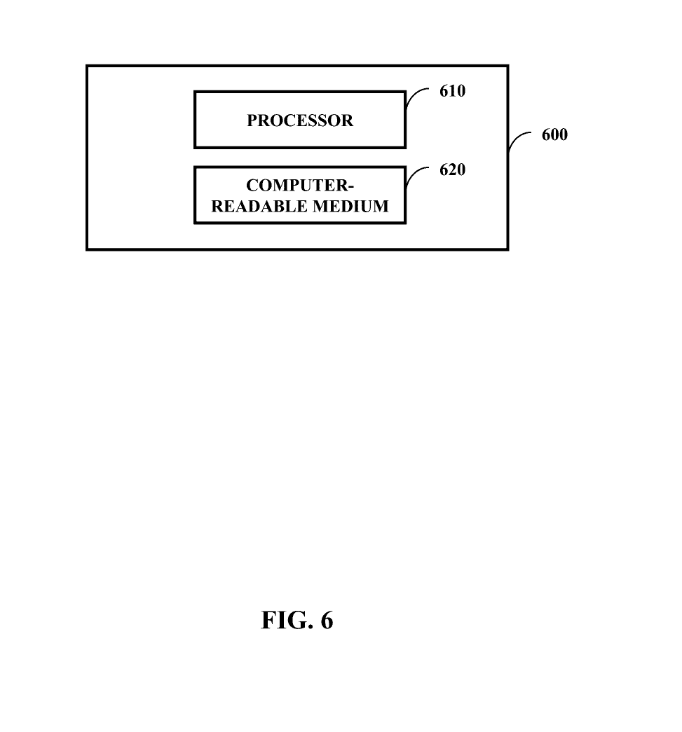

FIG. 6 illustrates one embodiment of a system 600 comprising a processor 610 and a computer-readable medium 620 (e.g., non-transitory computer-readable medium). In one embodiment, the computer-readable medium 620 is communicatively coupled to the processor 610 and stores a command set executable by the processor 810 to facilitate operation of at least one component disclosed herein (e.g., e.g., the assignment component 210 of FIG. 2). In one embodiment, at least one component disclosed herein (e.g., the transfer component 220 of FIG. 2) can be implemented, at least in part, by way of non-software, such as implemented as hardware by way of the system 600.

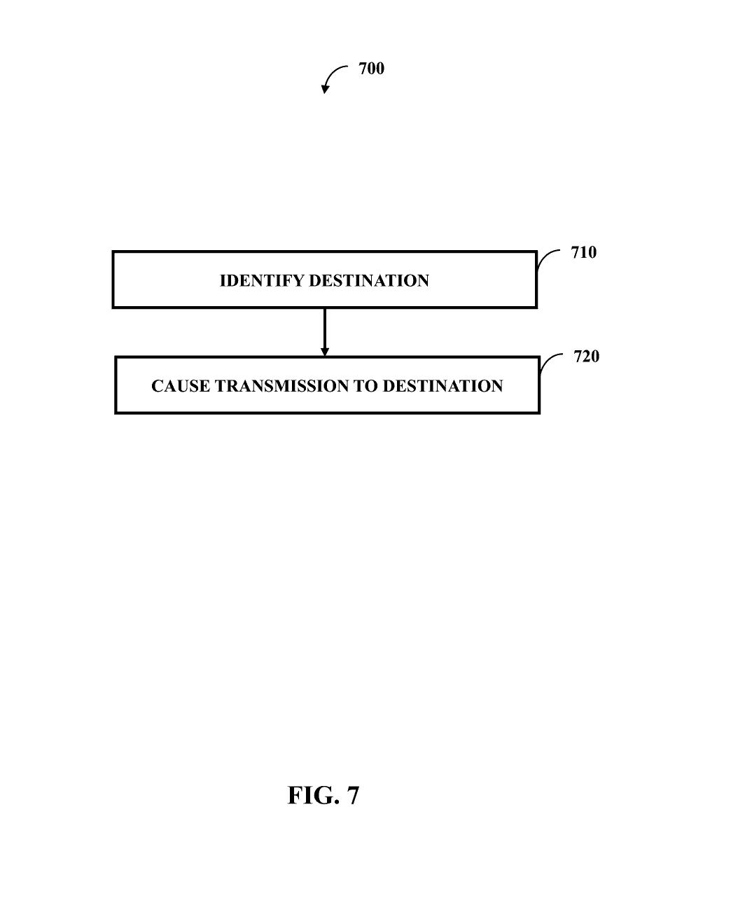

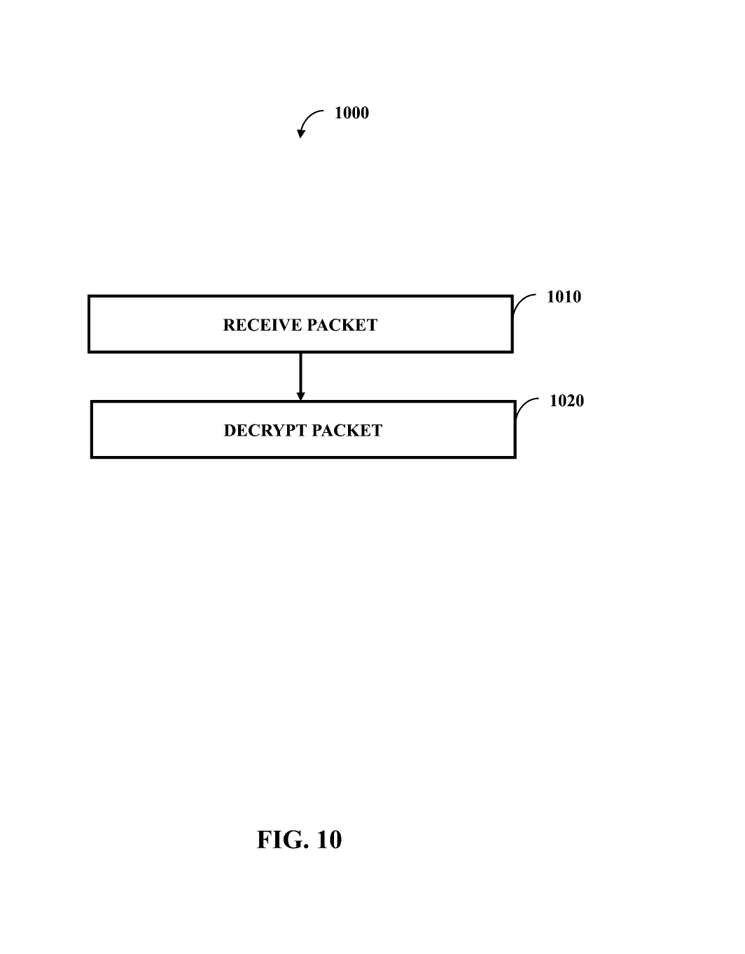

In one embodiment, the computer-readable medium 620 is configured to store processor-executable instructions that when executed by the processor 610 cause the processor 610 to perform a method disclosed herein (e.g., the methods 700-1100 addressed below). Methods disclosed herein can be performed by the bi-color routers 130 of FIG. 1. The bi-color router 130 of FIG. 1 can be configured to perform multiple method (e.g., the method 700 of FIG. 7 and the method 1000 of FIG. 10 both discussed below).

FIG. 7 illustrates one embodiment of a method 700 comprising two actions 710-720. At 710 there can be identifying a destination enclave for a packet (e.g., the packet 240 of FIG. 2). At 720 there can be causing a transmission of the packet the destination enclave. The packet can retain an information set that indicates the destination enclave and the information set and/or contents of the packet itself (e.g., non-source/destination information) can be masked to the intermediary network. The transmission of the packet to the destination enclave can include travel across an intermediary network. The destination enclave and the transmission enclave share can a security level that is of a higher level than a security level of the intermediary network. The transmission enclave, the destination enclave, and the intermediary network can share a common protocol.

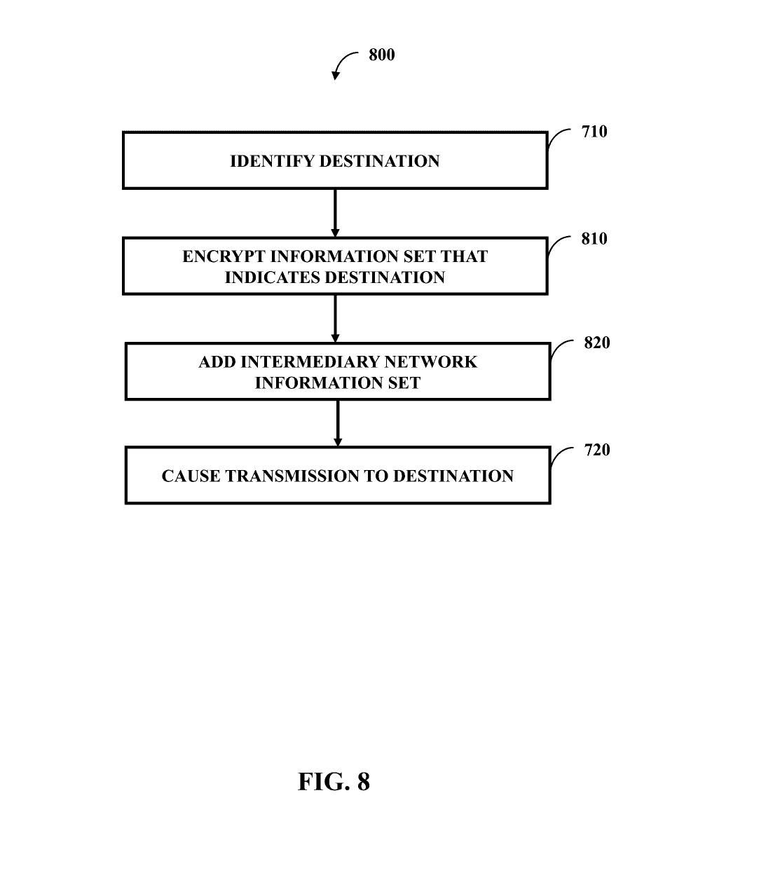

FIG. 8 illustrates one embodiment of a method 800 comprising four actions 710-720 and 810-820. The destination enclave can be identified at 710 and at 810 encrypting the information set can occur in a manner intelligible to the transmission enclave and the destination enclave, but not intelligible to the intermediary network prior to causing the transmission. At 820 there can be adding to the packet an intermediary network destination information set, that is not intelligible to the intermediary network, prior to causing the transmission that occurs at 720. Additionally, there can be, at 820, adding to the packet an intermediary network source information set, which is intelligible to the intermediary network, prior to causing the transmission that occurs at 720. The intermediary network source information set can indicate a location (e.g., a bi-color router 130 of FIG. 1) where the transmission enclave interfaces with the intermediary network such that the packet enters the intermediary network.

In one example with regard to FIG. 1, the transmission enclave can be red enclave 3 of FIG. 1. The red enclave 3 of FIG. 1 can interface with the black core portion 110 of FIG. 1 that functions as the intermediary network at a first interface location that can be the bi-color router 130 of FIG. 1 named “P.” The intermediary network can read the intermediary network destination information set and then transfer the packet, which can be masked to the intermediary network, to a second interface location. With this example, the final destination can be the red enclave 4. The packet itself can be masked to the black core portion 110 of FIG. 1, as can the final destination of the red enclave 4, but the bi-color router 13 of FIG. 1 named “Q” can be available for reading by the black core portion 110 of FIG. 1. The bi-color router 13 of FIG. 1 named “Q” can be the second interface location that interfaces with the destination enclave, here red enclave 4 of FIG. 1.

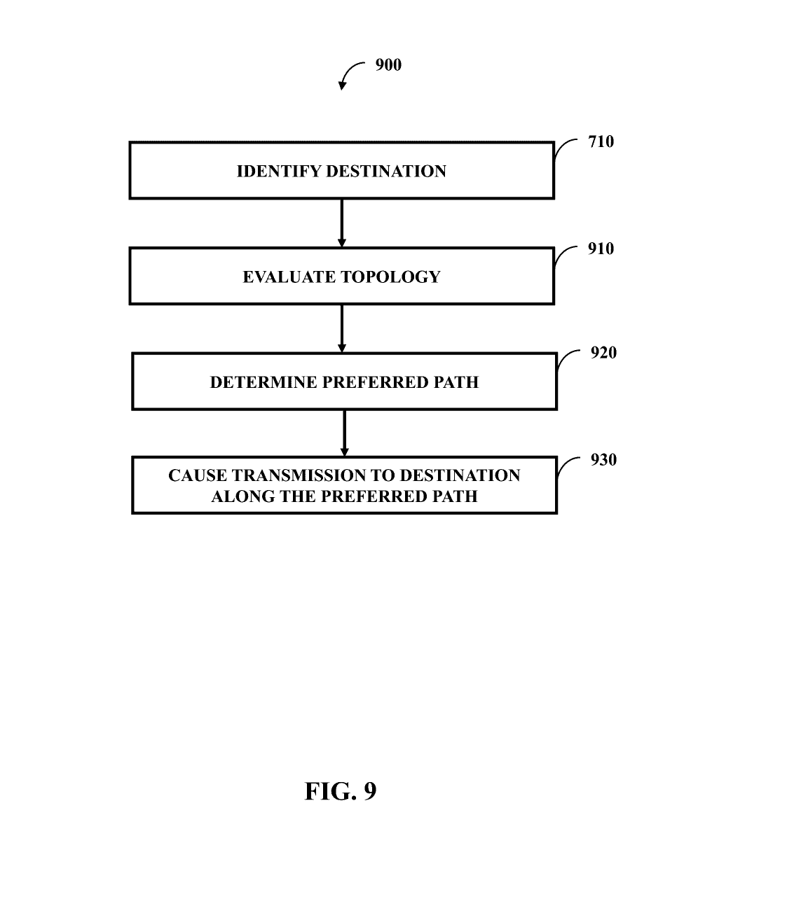

FIG. 9 illustrates one embodiment of a method 900 comprising four actions 710 and 910-930. The destination enclave can be identified at 810 and at 910 evaluating a topology representation of an overall network (e.g., the network 100 of FIG. 1) to produce an evaluation result can take place. This evaluation can occur before destination enclave identification, during destination enclave identification, after destination enclave identification, or a combination thereof. At 920 there can be determining a preferred path for the packet from the transmission enclave and to the destination enclave based, at least in part, on the evaluation result. At 930, causing a transmission of the packet can occur along the preferred path along at least part of the intermediary network and to the destination enclave.

Evaluating the topology representation of the overall network can include various actions. The overall network can comprise the intermediary network, the transmission enclave, the destination enclave, and various bi-color routers 130 of FIG. 1. At 910, as part of the evaluation, information on the overall network can be collected and the topology representation can be construed based, at least in part, on the collected information. This collection and construction can include building a new topology representation or updating an existing topology representation. Once constructed or updated, the topology representation can be assessed to produce an assessment result that can be the evaluation result.

FIG. 10 illustrates one embodiment of a method 1000 comprising two actions 1010-1020. At 1010, a packet can be received from a first bi-color router 130 of FIG. 1 that encrypted the packet at a second bi-color router 130 of FIG. 1. At 1020, decrypting the packet can occur at the second bi-color router 130 of FIG. 1. The destination enclave and the submission enclave can share a security level that is of a higher level than a security level of the intermediary network. The submission enclave (e.g., a red enclave 120 of FIG. 1), the destination enclave (e.g., a red enclave 120 of FIG. 1 that is different from the submission enclave), and the intermediary network (e.g., the black portion 110 of FIG. 1) can share a common protocol.

The packet can travel from a submission enclave to the first bi-color router 130 of FIG. 1 that interface the submission enclave. From the first bi-color router 130 of FIG. 1, the packet can travel along the intermediary network to the second bi-color router 130 of FIG. 1. The packet can then travel from the second bi-color router 130 of FIG. 1 to the destination enclave.

The packet can be partially encrypted and partially non-encrypted (e.g., final destination information and packet substance is encrypted, but the intermediary network destination is not encrypted). Being encrypted and non-encrypted can be generally based or be perspective based. In an example of general encryption, part of the packet can be encrypted while another part of the packet is absent encryption. In an example of perspective-based encryption, the packet can have at least two parts—a first part and a second part. Both these parts can be encrypted, but the first part can have a higher level of encryption than the other part. In this example, the first part can be an actual network source address (e.g., a red enclave 120 of FIG. 1) and the second part can be an intermediary network source address (e.g., a bi-color router 130 of FIG. 1). While both of these can have a level of encryption, the actual network source can be encrypted outside of the red enclaves 120 of FIG. 1 while the intermediary network source can be encrypted outside the network 100 of FIG. 1.

Different information can be included in the encrypted and non-encrypted portions. In one example, the packet can include a portion that is non-encrypted to the intermediary network and can be used by the intermediary network to transmit the packet to the first router. An example of the portion that is non-encrypted to the intermediary network can be source information that describes the second router (e.g., an address of the second router). The packet can also comprise a portion that is encrypted to the intermediary network, such as an address of the submission enclave.

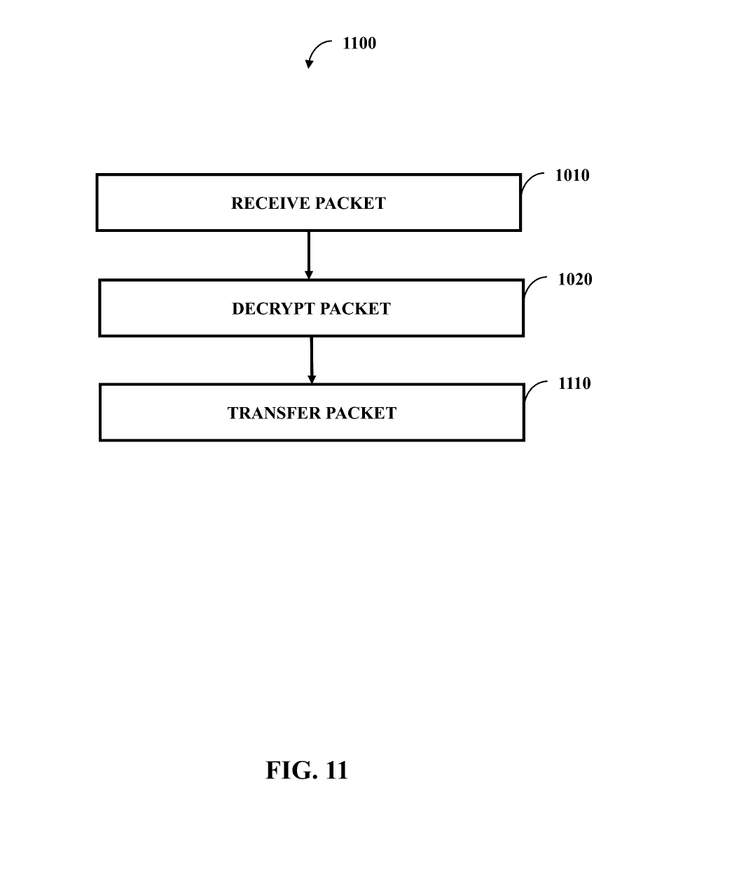

FIG. 11 illustrates one embodiment of a method 1100 comprising three actions 1010-1020 and 1110. At 1110 there can be transferring the packet to a second destination enclave along an enclave network without traversing the intermediary network after the packet is received. This can use the interconnection between the red enclave 1 of FIG. 1 and the red enclave 2 of FIG. 1 such that a packet sent for red enclave 3 of FIG. 1 can transfer along the black core portion of FIG. 1 to the red enclave 2 and then transfer along to red enclave 1 along a secure channel.

While the methods disclosed herein are shown and described as a series of blocks, it is to be appreciated by one of ordinary skill in the art that the methods are not restricted by the order of the blocks, as some blocks can take place in different orders. Similarly, a block can operate concurrently with at least one other block.

What is claimed is:

1. A method, performed, at least in part, by a network device, comprising:
identifying a destination enclave for a packet; and
causing a transmission of the packet to the destination enclave,
where the transmission of the packet to the destination enclave includes travel across an intermediary network,
where the destination enclave and a transmission enclave that supplies the packet share a security level that is of a higher level than a security level of the intermediary network, and
where the transmission enclave, the destination enclave, and the intermediary network share a common protocol.

2. The method of claim 1,
where the packet retains an information set that indicates the destination enclave and
where the information set is masked to the intermediary network.

3. The method of claim 2, comprising:
encrypting the information set in a manner intelligible to the transmission enclave and the destination enclave, but not intelligible to the intermediary network prior to causing the transmission; and
adding to the packet an intermediary network destination information set, that is not intelligible to the intermediary network, prior to causing the transmission,
where the transmission enclave interfaces with the intermediary network at a first interface location that is the router,
where the intermediary network reads the intermediary network destination information set and then transfers the packet to a second interface location, and
where the destination enclave interfaces with the second interface location.

4. The method of claim 3, comprising:
adding to the packet an intermediary network source information set, that is intelligible to the intermediary network, prior to causing the transmission,
where the intermediary network source information set indicates a location where the transmission enclave interfaces with the intermediary network such that the packet enters the intermediary network.

5. The method of claim 2, where the packet is masked to the intermediary network.

6. The method of claim 1, comprising:
evaluating a topology representation of an overall network to produce an evaluation result; and
determining a preferred path for the packet to the destination enclave based, at least in part, on the evaluation result,
where the overall network comprises the intermediary network, the transmission enclave, and the destination enclave and
where the preferred path includes at least part of the intermediary network.

7. The method of claim 6, comprising:
collecting an information on the overall network; and
constructing the topology representation based, at least in part, on the information of the overall network.

8. A method, performed, at least in part, by a first router that interfaces a destination enclave with an intermediary network, comprising:
receiving a packet, that is partially encrypted, from a second router that encrypted the packet that travels by way of the intermediary network; and
decrypting the packet,
where the second router interfaces with a submission enclave,
where the intermediary network that is incapable of decrypting the packet,
where a destination enclave and the submission enclave share a security level that is of a higher level than a security level of the intermediary network and
where the submission enclave, the destination enclave, and the intermediary network share a common protocol.

9. The method of claim 8,
where the packet includes a portion that is non-encrypted to the intermediary network and
where the portion that is non-encrypted to the intermediary network is used by the intermediary network to transmit the packet to the first router.

10. The method of claim 9, where the portion that is non-encrypted to the intermediary network comprises source information that describes the second router.

11. The method of claim 10, where the packet comprises a portion that is encrypted to the intermediary network and that indicates an address of the submission enclave.

12. The method of claim 8, comprising:
transferring the packet to a second destination enclave along an enclave network without traversing the intermediary network after the packet is received.

13. A system, comprising:
an assignment component configured to assign an intermediary network destination information set to a packet with a final destination information set; and
a transfer component configured to cause transmission of the packet with the intermediary network destination information set from a multi-color router, along an intermediary network, toward a destination enclave,
where the final destination information set corresponds to the destination enclave,
where the final destination information set is intelligible to a transmission enclave operatively coupled to the multi-color router,
where the final destination information set is intelligible to the destination enclave,
where the final destination information set is not intelligible to the intermediary network,
where the intermediary network destination information set is a final destination of the intermediary network,
where the final destination of the intermediary network is accessible by the destination enclave,
where the transmission enclave, the destination enclave, and the intermediary network share a common protocol, and
where the assignment component, the transfer component, or a combination therefore are implemented, at least in part, by way of non-software.

14. The system of claim 13, where the intermediary network destination information set corresponds to the destination enclave.

15. The system of claim 13, comprising:
an identification component configured to identify a source of the packet; and
an addition component configured to a source information set to the packet that indicates the source.

16. The system of claim 13,
an encryption component configured to encrypt the final destination information set such that the final destination information set is intelligible to the transmission enclave, the final destination information set is intelligible to the destination enclave, and the final destination information set is not intelligible to the intermediary network; and
a decryption component configured to decrypt a second final destination information set of a second packet that is different from the packet.

17. The system of claim 13,
where the final destination of the intermediary network interfaces with a transitional enclave and
where the packet travels from the transitional enclave to the destination enclave without return to the intermediary network.

18. The system of claim 13, comprising:
an analysis component configured to analyze a topology of the intermediary network and at least one enclave that interfaces the intermediary network to produce an analysis result; and
a path component configured to calculate a preferred path for the packet from the multi-color router and to the destination enclave based, at least in part, on the analysis result,
where the transfer component is configured to cause transmission of the packet along the preferred path.

19. The system of claim 13, where the packet, absent the intermediary network destination information set, is not intelligible to the intermediary network.

20. The system of claim 13, where the assignment component and the transfer component reside upon the multi-color router.
